(19) United States
(12) Patent Application Publication
(10) Pub. No.: US 2001/0021596 A1
(43) Pub. Date: Sep. 13, 2001

(54) Deformable contact connector supported by constant force clamping spring

(76) Inventor: Akira Tamura, Yokohama (JP)

Correspondence Address: COUDERT BROTHERS, Suite 3300, 4 Embarcadero Center, San Francisco, CA, 94111, US

(21) Appl. No.: 09/853,327

(22) Filed: May 10, 2001

Related U.S. Application Data
(63) Continuation of application No. 09/437,577, filed on Nov. 9, 1999.

(51) Int. Cl. H01R 12/00

(52) U.S. Cl. 439/66

(57) ABSTRACT

A system for electrically connecting two sets of conductive pads or contacts. The system includes an interposer having conductive bumps on each of two opposing surfaces, with each bump on one surface being electrically connected by a conductive via to a corresponding bump on the opposing surface. The connector system acts to maintain electrical contact between each set of bumps and a corresponding set of conductive pads, thereby electrically connecting the two sets of pads. The bumps on each surface of the interposer are deformable and are placed into physical contact with the corresponding set of pads. The bumps and pads are maintained in good electrical contact by the force supplied by a clamping spring, which causes the bumps to deform until the contact area between a bump and a pad is sufficiently large to reduce the resistance between the bump and pad to a desired value. The clamping spring is of a type capable of exerting an approximately constant force over the set of bump/pad interfaces over a range of deflections arising from displacements of the components of the connector system. The combination of deformable bumps and constant force spring acts to maintain good electrical contact between the bumps and pads over the lifetime of the connector

### BACKGROUND OF THE INVENTION

1. Field of the Invention

The present invention relates to the packaging of semiconductor devices, and more specifically, to an electrical connector system including deformable bumps which are maintained in good electrical contact with a set of conductive pads by a clamping spring. The spring is specifically selected to exert an approximately constant force over the range of working displacements of the system components.

2. Description of the Prior Art

Electrical connectors are used in many ways in the assembly of semiconductor devices and computer products. For example, connectors may be used to connect a device or module's bonding pads to the conductive pads of an interconnect substrate, the I/O pads of a substrate to the pads of a package, or the contact pads of a package to those of other packages. Metal bump connectors are an example of a high pin count, small pin pitch connector conventionally used in the assembly of multi-chip modules and packages of such modules. A bump connector includes a group of raised conductive contacts or bumps on its face which are placed in physical contact with the bonding pads of a substrate. The bumps and bonding pads are maintained in good electrical contact by elastomer pads and/or mechanical springs which apply a biasing force to prevent significant movement of the bumps relative to the pads.

The bonding pads on two separate substrates may be maintained in electrical contact by using an interposer structure placed between the two sets of pads. The interposer typically has bumps on two opposing planar surfaces, where corresponding members of the two sets of bumps are electrically connected together by conductive vias.

FIG. 1 is a side view of a conventional bump connector 100. Connector 100 typically includes a plurality of bumps 102 formed on a substrate 104. Bumps 102 may be electrically connected to circuit elements or other contacts by means of an interconnect network formed on substrate 104. When using connector 100, it is desired to establish and maintain electrical contact between bumps 102 and pads 106 of another circuit element, for example, flexible circuit 108, or a set of conductive elements on another type of substrate. This can be accomplished by placing a clamping plane or pressure plate 110 on top of the flexible circuit and a second clamping plane underneath substrate 104. The two clamping planes 110 are held together by bolts or an element supplying a biasing force (not shown), thereby maintaining physical and electrical contact between bumps 102 and pads 106.

A problem encountered with this connector design is that the bump/pad interfaces can have a large range of resistance among them, with this variation in resistance arising from several sources. One source is that the material from which the bumps are made typically has a small range of elasticity. This means that the face surface of the bump in contact with the bonding pad may not always deform enough to assure good electrical contact (i.e., contact over a sufficiently large surface area so that the resistance is low enough for desired operation). Also, because the individual bumps often vary in height, differential thermal expansion and contraction of the connector materials or at the bump/pad interface can cause some of the bumps to suffer a reduction in the contacting force which maintains the bumps and bonding pads in good electrical contact. This means that the electrical contact, and hence resistance, between the bumps and the bonding pads is not uniform and may not remain constant over the lifetime of the connector. Another cause of resistance variation between the bump/pad interfaces is stress relaxation in the material from which the bumps are made.

In order to apply a more uniform biasing force and thereby maintain good electrical contact between the bumps and the bonding pads over time, an elastomeric pad may be inserted between the circuit element which serves as the substrate for the bonding pads and the clamping plane placed on top of the circuit. FIG. 2 is a side view of the bump connector of FIG. 1 to which has been added an elastomeric pad 112. Elastomeric material 112 assists in equalizing the pressure across the set of bumps, and also provides additional elastic range to the elasticity of the bumps. When the connector includes an elastomeric layer, harder (less elastic) bumps apply a greater force to the layer. The layer responds by “giving” somewhat so that harder or higher bumps are pushed farther into the layer than softer or lower bumps. This serves to compensate for the non-uniform height and elasticity of individual bumps. The elastomeric layer thus acts to equalize the normal contact force on the bumps, with the result that better electrical contact is maintained between the set of bumps and the conductive pads. Although this design reduces the problems caused by height and/or hardness variations between bumps, the contact force may decrease over time (i.e., a decrease in the clamping pressure) due to creep in the elastomeric layer. This reduces the degree of electrical contact between the bumps and the pads, thereby increasing the resistance at the bump/pad interfaces.

What is desired is an electrical bump connector or connector system which is capable of maintaining good electrical contact between the bumps and a set of conductive pads, and which does not suffer a reduction in the force holding the bumps and pads in contact over time, in the manner of conventional designs.

### SUMMARY OF THE INVENTION

The present invention is directed to a system for electrically connecting two sets of conductive pads or contacts. The system includes an interposer having conductive bumps on each of two opposing surfaces, with each bump on one surface being electrically connected by a conductive via to a corresponding bump on the opposing surface. The connector system acts to maintain electrical contact between each set of bumps and a corresponding set of conductive pads, thereby electrically connecting the two sets of pads through the intermediary of the interposer. The bumps on each surface of the interposer are deformable and are placed into physical contact with the corresponding set of pads. The bumps and pads are maintained in good electrical contact by a force supplied by a clamping spring, which causes the bumps to deform until the contact area between a bump and a pad is large enough to reduce the resistance between the bump and pad to a desired level. The clamping spring is of a type capable of exerting an approximately constant force to the set of bump/pad interfaces over a range of deflections arising from displacements of the components of the connector system. The combination of deformable bumps and constant force spring acts to maintain good electrical contact between the bumps and pads over the lifetime of the connector.

### BRIEF DESCRIPTION OF THE DRAWINGS

FIG. 1 is a side view of a conventional bump connector.

FIG. 2 is a side view of the bump connector of FIG. 1 to which has been added an elastomeric pad.

FIG. 3(a) is a side view of an embodiment of the deformable contact connector of the present invention which includes a deformable bump interposer.

FIG. 3(b) is a graph of the clamping force versus bump displacement for the embodiment of the deformable bump connector of the present invention shown in FIG. 3(a).

FIG. 3(c) is a graph of the clamping force versus clamping spring displacement for the embodiment of the deformable bump connector of the present invention shown in FIG. 3(a).

FIG. 4(a) are side views showing how the bumps of the connector are deformed when a sufficient clamping force is applied.

FIG. 4(b) is a graph of the normal clamping force applied to a bump versus the bump displacement.

FIG. 5(a) is a side view showing how the minimum clamping force required to maintain good electrical contact may be determined.

FIG. 5(b) is a graph of the applied clamping force versus bump displacement for the bumps shown in FIG. 5(a).

FIG. 6(a) is a graph of load versus displacement for a canted coil spring of the type which may be used in the present invention.

FIG. 6(b) is a graph of load versus displacement for a super elastic alloy spring of the type which may be used in the present invention.

FIGS. 7-9 are side views of possible embodiments of the present invention, showing different bump and bonding pad configurations.

FIG. 10 is a side view showing how the deformable bump connector system of the present invention may be used to electrically connect a multi-chip module to a substrate.

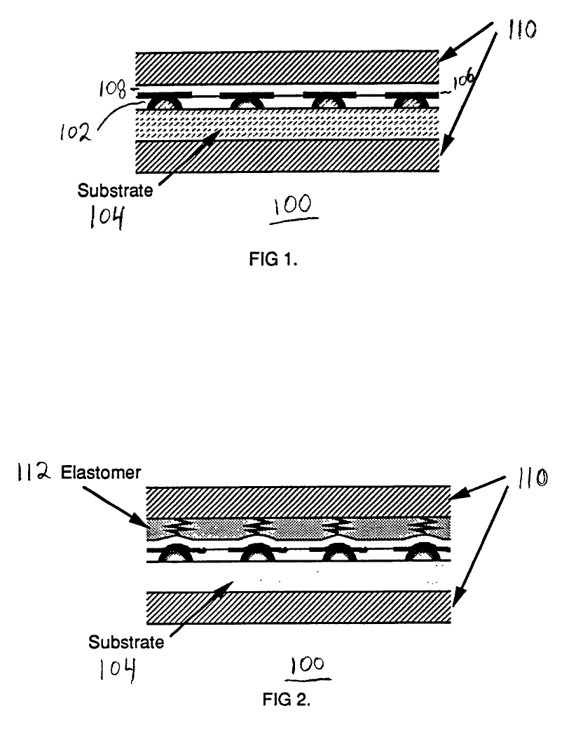

### DETAILED DESCRIPTION OF THE INVENTION

The present invention is a design for an electrical connector system which can be used to establish and maintain good electrical contact between two sets of bonding pads or between two sets of conductive pins over time. The connector may be used to connect a multi-chip module to, a substrate or to connect the I/O pins of circuit modules together, as well as other situations in which electrical connectors are used. The connector system of the present invention includes an interposer having a set of deformable conductive bumps and a spring capable of exerting an approximately constant clamping force over the set of bumps despite displacements in the relative positions of components of the connector system. These elements are used to establish a low resistance contact between the bumps and a set of bonding pads, and to maintain that contact over the lifetime of the connector.

The combination of deformable bumps and constant force spring permits the connector to adjust to variations in the bump sizes and shapes, and to displacements of the connector components arising from differential thermal expansion/contraction, etc. It also acts to prevent a reduction in the force applied to the bumps holding them in contact with a set of bonding pads, which can occur over time with connectors which utilize an elastomeric layer.

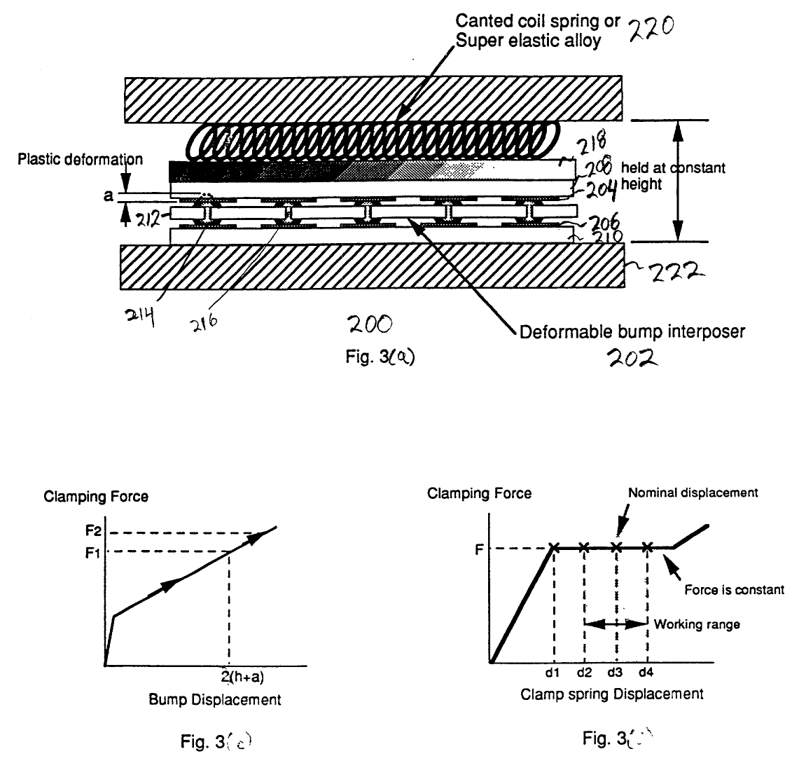

FIG. 3(a) is a side view of an embodiment of the deformable contact connector of the present invention 200 which includes a deformable bump interposer 202. In the embodiment shown in the figure, connector 200 is designed to electrically connect a first 204 and a second 206 set of bonding pads. Bonding pads 204 and 206 are typically formed on respective substrates 208 and 210, which may be integrated circuit chips or part of interconnection networks, for example. Deformable bump interposer 202 comprises an interposer plate 212, having two substantially planar, opposing surfaces. On each surface is a plurality of electrically conducting bumps 214, typically formed from a metal or other suitable conductive material. Corresponding bumps 214 on opposite sides of plate 212 are electrically connected by conductive vias 216 which pass through interposer plate 212. Interposer plate 212 may be made of a rigid or semi-rigid dielectric material, such as polyimide or a ceramic. Vias 216 are typically formed from a conductive material such as copper.

Interposer 202 may be formed in any of a number of ways. Two exemplary methods will be described, where the first method is suitable for forming comparatively large-area bumps (typically >100 μm diameter) with comparatively large separation (pitch) between bumps, and where the second method is suitable for forming comparatively small-area bumps (typically <100 μm diameter ) with comparatively small separation between bumps.

In the first method, through holes are formed in a rigid or flexible substrate, such as by drilling, laser drilling, punching or photo-definition (in the case of photosensitive polymeric films). The through holes are then plated with copper material by any of the well-known through-hole plating methods. These methods generally laminate photoresist layers on each side of the drilled substrate, and then photo-pattern apertures at the ends of the through holes. Next, the walls of the through holes are treated with a plating catalyst, and then are electrolessly plated. Once an initial layer has been formed, the core of the through holes may be filled using a conventional electroplating process.

Having filled the through holes with copper or another suitable material to form conductive vias, the exposed ends of the vias in the interposer may then be electrolessly plated with soft gold (or other suitable metal) by any of the well known electroless plating processes. Prior to plating, the ends of the vias are treated by a conventional plating catalyst. During the electroless plating process, material uniformly forms around each via end to produce a semi-hemispherical bump. Such methods are more fully disclosed in U.S. Pat. No. 5,515,604, assigned to the assignee of the present application, and the contents of which is hereby incorporated by reference.

However, the electroless plating method is relatively slow for the purpose of making bumps with heights greater than about 25 μm. In such a situation, a faster method of electroplating (or electrolytic plating) may be used in the following manner. A thin conductive layer may be formed on the first surface of the interposer, such as by evaporation or sputtering, to act as a common electrode for the electroplating process. A mask layer, such as black wax, is formed over the conductive layer to prevent material from being plated to it. The plating clip, which can readily break through the mask layer, is attached to the interposer to make contact to the common electrode. Bumps are then plated on the via ends at the second surface using a conventional electroplating process. With the bumps formed, the plating mask is removed (such as by using organic solvents or strippers), and the conductive layer is removed (such as by using conventional wet etchants for metals). The thin conductive layer may comprise a different material from that of the vias, and a selective etchant may be used. The bumps on the first surface may be masked during the wet etching of the thin conductive layer.

Next, a second, thin conductive layer is formed over the second surface and the previously formed bumps. A plating mask is disposed over the second surface, and bumps are electroplated onto the via ends at the first surface. The second, thin conductive layer and its plating mask may then be removed as described above.

A second method, which is suitable for forming an interposer having comparatively small-area bumps (<100 μm diameter) with small pitch between bumps, is disclosed in U.S. Pat. No. 4,926,549 to Yoshizawa, et al., the contents of which is hereby incorporated by reference. In this method, a dielectric layer, such as polyimide, is formed on a sacrificial conductive substrate. Apertures are formed in the dielectric layer to expose the sacrificial substrate. An isotropic chemical etch is then used to etch semi-hemispherical recesses into the locations of the sacrificial substrate which have been exposed by the apertures. Next, the recesses and the apertures are filled with soft gold by electroplating, using the conductive substrate as the cathode. This forms via connectors with rounded bump ends at the bottom surface of the dielectric layer due to the shape of the recesses.

The plating operation is continued so that the conductive gold rises above the top surface of the dielectric layer, thereby forming rounded bump ends at the top surface. After the plating operation, the sacrificial substrate is etched away by a selective chemical etching process to free the dielectric layer and the gold conductive connectors.

After formation, deformable bump interposer 202 is positioned between substrates 208 and 210, and aligned so that each bump 214 is in physical contact with a corresponding bonding pad (element 204 or 206) on the respective sides of interposer 202. A pressure plate 218 may be positioned on top of substrate 208 to more evenly distribute the clamping force which will be applied by constant force spring 220. A clamping plane or plate 222 is positioned above spring 220 and below substrate 210. The two clamping planes are held at a fixed relative separation by bolts or another attachment device (not shown).

After clamping, each bump 214 will deform until the contact pressure within the bump reduces to a level below the yielding stress of the bump material. The desired connector clamping force to achieve the proper degree of plastic deformation and maintain good electrical contact between the bumps and pads is a function of the mechanical properties of the contact pad material, the bump material, and their shapes. The normal force is selected to control the amount of bump deformation and ensure that the bump material passes through the elastic deformation region and enters the plastic (inelastic) regime. Since the plastic deformation of the bump material will decrease and stop as the bump flattens and presents a greater area to the contact pad, the constant force clamping spring will force the bumps into an equilibrium shape and then will maintain a substantially uniform force over the bump/pad interfaces during the lifetime of the connector. This will maintain a good electrical connection between the bumps and the contact pads.

Bumps 214 are formed from a conductive material which is sufficiently deformable under the expected range of applied forces. Suitable materials are soft ductile metals, such as soft gold, indium, or lead. If the bump material is readily oxidized, the bump surface can be provided with a protective coating, e.g., a thin layer of nickel or gold. The bump material should be deformable to the extent required to provide sufficient contact area between the deformed bump surface and the contact pad to transfer a desired current level at a low enough resistance. It is noted that although FIG. 3(a) shows an embodiment of the present invention in which a deformable bump is contacted to a harder pad, other combinations of relative bump and pad hardness may be used. For example, a hard bump and deformable pad or a deformable pad and deformable bump may also be used as part of the invention.

FIG. 3(b) is a graph of the clamping force versus bump displacement (deformation) for the embodiment of the deformable bump connector of the present invention shown in FIG. 3(a). Force F1 is the clamping force required to produce a total bump displacement of 2(h+a), where (h) is the maximum variation in bump height and (a) is the minimum desired displacement in height of the bumps arising from the deformation. The factor of two enters because in the embodiment shown in FIG. 3(a), there are bumps on two sides of the interposer. Force F1 is the clamping force sufficient to produce a displacement for all the bumps that enables the bumps to have an adequate normal force and contact area to provide a good electrical connection.

FIG. 3(c) is a graph of the clamping force versus clamping spring displacement for the embodiment of the deformable bump connector of the present invention shown in FIG. 3(a). Displacement (d1) corresponds to the spring displacement when the bumps are deformed by the amount 2(h+a). The value (d3) corresponds to a nominal displacement of the clamping spring, which has marginal displacements (d3−d2) and (d4−d3) on either side of (d3). The magnitude of the marginal displacement(s) is a factor of the thermal coefficient of expansion of the spring, creep, manufacturing tolerances, etc. Note that the clamping force exerted by the spring is substantially constant over the spring displacement range from d2 to d4. This is desired to maintain the relative positions and electrical contact between the bumps and the contact pads (after deformation of the bumps) over a range of possible spring deflections. Such deflections can arise from changes in the relative positions of the components of the connector system as a result of parts tolerances, differential thermal expansion/contraction, elastomeric creep, etc. Thus, the range of clamping spring displacement from d2 to d4 (and hence the corresponding approximately constant spring clamping force) constitutes a desirable working range for the connector system of the present invention (and corresponds to the range of motions expected for the system components during the lifetime of the connector system).

Referring back to FIG. 3(b), if it is known that clamping force F2 causes sufficient bump deformation to provide adequate contact area between the bumps and the corresponding pads, and that force F1 provides an adequate normal force to maintain each individual bump/pad contact, then a sequential combination of the forces could be applied to obtain the final connector configuration. For example, force F2 could be applied by means of a pressing device other than the clamping spring, and then force F1 could be applied by the constant force clamping spring, with the force level F1 maintained during the use of the connector.

As noted, a desired characteristic of the clamping spring is that it be capable of maintaining an approximately constant force on the bump/pad interfaces over a typical range of working deflections expected to occur during the lifetime of the connector. This is in contrast to standard springs which exert a restoring force proportional to the amount of deflection.

By using a clamping spring which exerts a spring force that is approximately constant over a range of deflections, the connector system can perform as intended over a range of parts tolerances, temperature changes, etc., which may occur during manufacture or over the lifetime of the device. Two possible constant force springs suitable for use in the present invention are a canted coil spring of the type available from Bal Seal Engineering Company, Inc. of Santa Ana, Calif., or a super elastic alloy spring formed from a shaped memory alloy (e.g., Ni—Ti).

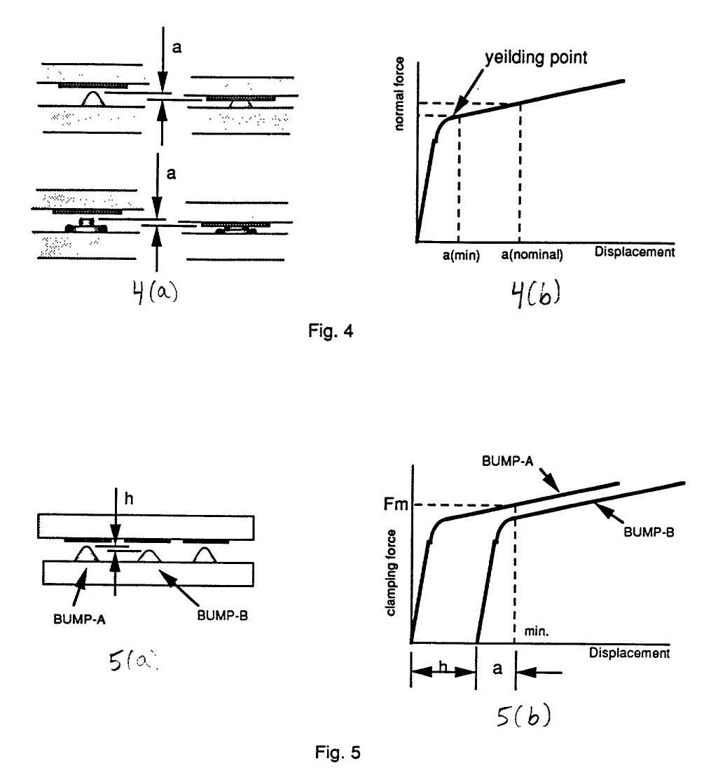

FIG. 4(a) are side views showing how the bumps of the interposer connector are deformed when a sufficient clamping force is applied. As shown, the bumps may have different shapes, which affects how that bump is deformed when a force is applied. The final bump shape impacts the electrical characteristics of the bump/pad interface and thus can affect the operation of the circuit of which the inventive connector is a part. This allows a designer to specify the bump shape which is most beneficial for the intended circuit applications (in terms of resistance, capacitance, signal propagation attributes, etc.). In FIG. 4(a), the quantity (a) is the amount of deformation of the bump. FIG. 4(b) is a graph of the normal clamping force applied to a bump versus the bump displacement. Once a contact pad begins applying a force to the bump, the bump deforms until the maximum applied stress balances the yielding stress in the bump. The minimum applied normal force is that which produces yielding of the bump material. This corresponds to a minimum satisfactory amount of bump displacement (labeled “a(min)” in the figure). The clamping force of the connector should equal the sum of the normal forces applied to each bump.

FIG. 5(a) is a side view showing how the minimum clamping force required to maintain good electrical contact is determined. FIG. 5(b) is a graph of the applied clamping force versus bump displacement for the bumps shown in FIG. 5(a). The clamping force should cause sufficient displacement to each bump to ensure that the necessary minimum normal force produces a displacement equal to or greater than (h+a), where again h is the maximum height variation in the bumps and a is the minimum desired displacement of the bumps. In a multi-bump design, the clamping force should be greater than F×N, where F is the force required for a displacement of (h+a) for one bump, and N is the number of bumps.

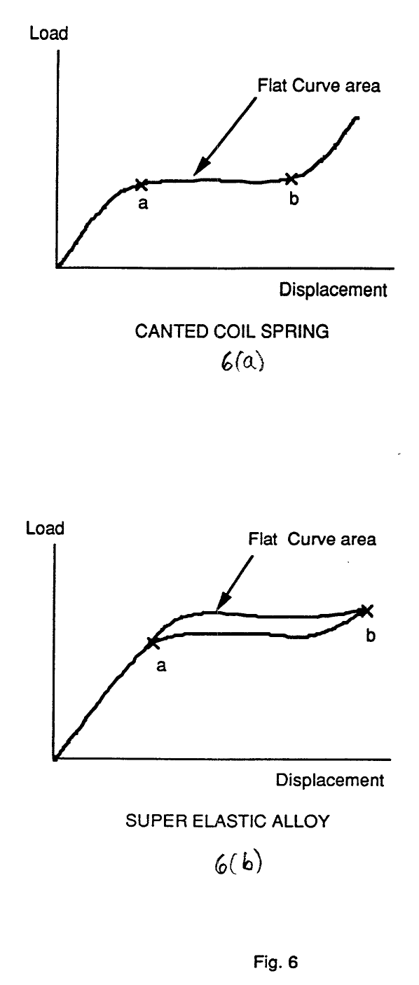

FIG. 6(a) is a graph of load versus displacement for a canted coil spring of the type which may be used in the present invention. As shown in the figure, the curve is substantially flat in the displacement range of (a) to (b). This means that in this deflection range, the spring can be used to apply an approximately uniform force to maintain the bumps and pads in contact, even though the connector system may contain materials that creep or vary in elasticity over time (and hence cause deflections or displacement of the spring). FIG. 6(b) is a graph of load versus displacement for a super elastic alloy spring of the type which may be used in the present invention. Again it is noted that the curve is substantially flat in the displacement range of (a) to (b). This is in contrast to standard springs which obey a force law described by F=−kx, i.e., the restoring spring force is proportional to the displacement (and hence varies with varying displacement).

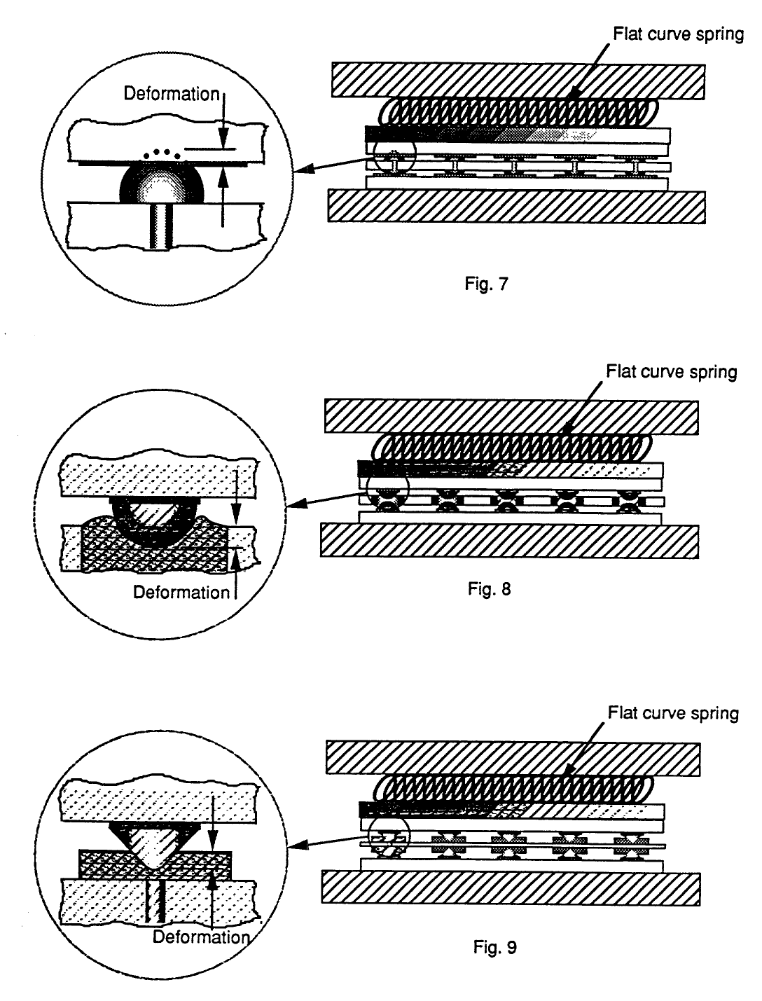

FIGS. 7-9 are side views of possible embodiments of the present invention, showing different bump and bonding pad configurations. For example, FIG. 7 shows an embodiment in which the interposer plate has deformable bumps on either side. The bumps deform when pressed against the comparatively harder contact pads. FIG. 8 shows an embodiment in which the interposer plate has a via having deformable top and bottom surfaces connecting the two sides. When the comparatively harder contact bumps are pressed against the top and bottom surfaces of the via, the surfaces deform. FIG. 9 shows an embodiment in which the interposer plate has a deformable pad on the top and bottom surfaces, with the pads connected by a conductive via. When the connector system is clamped, the comparatively harder contact bumps are pressed against the deformable pads. The “Flat curve spring” element shown in the figures is of the canted coil spring or super elastic alloy spring type previously discussed, or another suitable type of spring which satisfies the characteristics described.

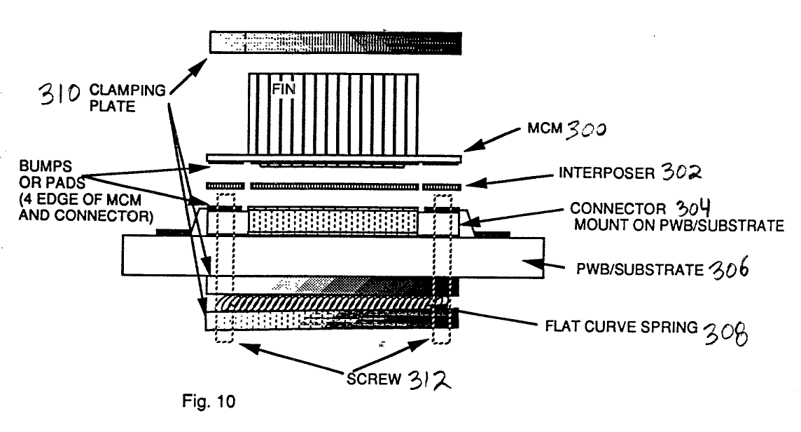

FIG. 10 is a side view showing how the deformable bump connector system of the present invention may be used to electrically connect a multi-chip module to a substrate. As shown in the figure, multi-chip module (MCM) 300 includes a set of contact bumps or pads which are to be placed in electrical contact with a set of connector bumps or pads. The connector bumps or pads are typically formed on a connector mount or substrate 304. Interposer 302 has deformable bumps or pads on its opposing top and bottom surfaces, with each bump or pad on one surface electrically connected to its corresponding bump or pad on the opposite surface by a conductive via. Connector mount 304 may be placed on another printed wiring board (PWB) or substrate 306. An approximately constant clamping force between the deformable bumps or pads of interposer 302 and those of multi-chip module 300 and connector 304 is maintained by use of flat curve spring 308 (i.e., a spring which exerts an approximately constant force over an expected range of deflections). Clamping plates 310 are arranged between spring 308 and substrate 306 and on the top and bottom of the connector structure as shown. The entire connector system may be held together by screws 312, pins, or another suitable connector.

A system for electrically connecting two sets of bonding or contact pads has been described. The system is especially well suited for use in the manufacture of high density, high I/O pin count electrical connectors. The inventive system uses a combination of deformable conductive bumps or surfaces and a clamping spring which exerts an approximately constant force over a range of expected displacements to establish and maintain good electrical contact between the sets of bonding pads over time.

The inventive system has several advantages over presently available connectors. Since the bumps are formed from a deformable conductive material and are deformed by application of a clamping force, a leveling process is not required during the manufacture of the bumps to ensure that all of the bumps have the same height. The height and material from which the bumps are fabricated and the clamping force may be varied to result in sufficient bump deformation to produce good electrical contact between the bumps and the corresponding pads or contacts. The clamping force exerted by the canted coil spring or super elastic alloy spring, for example, which is used in the invention is substantially constant over a range of displacements, resulting in constant contact forces, and hence uniform electrical properties over time. In addition, the bumps have an associated wiping action during assembly of the connector which will tend to clean away oxides and other contaminants from the bump/pad interfaces.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

What is claimed is:

1. An electrical connector assembly, comprising;
an interposer plate having substantially planar first and second opposing surfaces;
a plurality of deformable conductive regions disposed on each surface of the interposer plate;
a plurality of conductive vias electrically connecting each one of the conductive regions on the first interposer plate surface to a corresponding one of the conductive regions on the second interposer plate surface;
a first substrate on which are arranged a plurality of conductive contacts, wherein the conductive contacts are in physical contact with the conductive regions on the first interposer plate surface;
a second substrate on which are arranged a plurality of conductive contacts, wherein the conductive contacts are in physical contact with the conductive regions on the second interposer plate surface; and
a spring which exerts a substantially constant spring force as a function of spring displacement over a range of displacements encountered during use of the connector assembly, the spring arranged to apply a spring clamping force acting to maintain the conductive contacts of the first substrate in contact with the conductive regions on the first interposer plate surface and to maintain the conductive contacts of the second substrate in contact with the conductive regions on the second interposer plate surface.

2. The connector assembly of claim 1, further comprising:
a first clamping plate arranged on top of the spring and substantially parallel to the interposer plate;
a second clamping plate arranged beneath the second substrate and substantially parallel to the interposer plate; and
a connector holding the first and second clamping plates at a desired separation.

3. The connector assembly of claim 1, wherein the spring is a canted coil spring.

4. The connector assembly of claim 1, wherein the spring is a super elastic alloy spring.

5. The connector assembly of claim 1, wherein the interposer plate is formed from a dielectric material.

6. The connector assembly of claim 1, wherein the deformable conductive regions are formed from a material in the group consisting of gold, indium and lead.

7. The connector assembly of claim 1, wherein the conductive vias are formed from copper.

8. An electrical connector assembly, comprising:
a substrate on which are formed a plurality of deformable conductive regions; and
a spring which exerts a substantially constant spring force as a function of spring displacement over a range of displacements encountered during use of the connector assembly, the spring arranged to apply a spring clamping force acting to maintain the conductive regions on the substrate in contact with a set of conductive pads.

9. The connector assembly of claim 8, further comprising:
a second substrate on which is formed the set of conductive pads, wherein the conductive pads are in contact with the deformable conductive regions.

10. The connector assembly of claim 9, further comprising:
a first clamping plate arranged on top of the spring and substantially parallel to the first substrate;
a second clamping plate arranged beneath the second substrate and substantially parallel to the first substrate; and
a connector holding the first and second clamping plates at a desired separation.

11. The connector assembly of claim 8, wherein the spring is a canted coil spring.

12. The connector assembly of claim 8, wherein the spring is a super elastic alloy spring.

13. The connector assembly of claim 8, wherein the substrate is formed from a dielectric material.

14. The connector assembly of claim 8, wherein the deformable conductive regions are formed from a material in the group consisting of gold, indium and lead.

15. A method of electrically connecting a set of conductive pads to a set of electrical connector contacts, comprising:
placing the set of conductive pads in physical contact with the set of electrical connector contacts;
applying a force to the interfaces of the conductive pads and electrical connector contacts to deform the electrical connector contacts sufficiently to produce a desired degree of electrical contact between each conductive pad and a corresponding one of the electrical connector contacts; and
applying a force to maintain physical and electrical contact between the set of conductive pads and electrical connector contacts using a spring which exerts a substantially constant spring force as a function of spring displacement over a range of displacements encountered during use of the connector assembly.

16. The method of claim 15, wherein the step of applying a force to maintain physical and electrical contact between the set of conductive pads and electrical connector contacts further comprises:
applying the force using a canted coil spring.

17. The method of claim 15, wherein the step of applying a force to maintain physical and electrical contact between the set of conductive pads and electrical connector contacts further comprises:
applying the force using a super elastic alloy spring.
